(19) United States
(12) Patent Application Publication
(10) Pub. No.: US 2013/0311384 A1
(43) Pub. Date: Nov. 21, 2013

(54) LEASE DEPOSIT EXEMPTION POLICY

(71) Applicant: Keith Hatchett, Riviera Beach, FL (US)

(72) Inventor: Keith Hatchett, Riviera Beach, FL (US)

(21) Appl. No.: 13/764,759

(22) Filed: Feb. 11, 2013

Related U.S. Application Data
(63) Continuation-in-part of application No. 12/877,108, filed on Sep. 8, 2010, now abandoned.

(51) Int. Cl. G06Q 30/06

(52) U.S. Cl. CPC G06Q 30/0645
USPC 705/307

(57) ABSTRACT

A computerized method creates a deposit exemption policy between a lessor and a third party insurer, the policy obviating the need for a security deposit. The method includes the following steps: a) obtaining and processing information from a potential lessee, using a preprogrammed lease guaranty computer remote from the lessor, to carry out tasks of a lease control intermediary; b) storing with said lease control computer predetermined data regarding the potential lessee; c) requiring the lessor to follow a usual due diligence process for qualifying a lessee; d) optionally determining the specific amount based on payments from said lessee to said lessor; i) to be paid by the lease control intermediary to the lessor upon failure of said actual lessee to pay periodic lease payments; and ii) to be paid directly or indirectly by the lease control intermediary or a 3rd party insurer, upon injury on the property, to the injured party; and e) producing a physical manifestation of a certificate indicating a deposit exemption policy for a specific amount.

### TECHNICAL FIELD

This invention relates to a method for providing a lease deposit guaranty, and more particularly to creating a lease agreement between a lessor, lessee and a third party intermediary to obviate the need for a lessor to provide months of deposits prior to renting.

### BACKGROUND OF THE INVENTION

When a potential tenant applies to become a tenant of a property, the landlord typically runs a credit check on the potential tenant. The landlord may require a security deposit and/or a rental deposit (typically last month's rent), or if the credit check reveals a low credit score, the landlord may require a larger security deposit and multiple months pre-payment of rent, or the landlord may refuse to rent the property to the potential tenant.

Often the tenant may not have the large deposit and thus cannot rent the property. Also, once the property is rented by the tenant and the tenant moves to a different property, this rental process begins again.

In addition when a tenant rents property, the landlord often requires that the tenant obtain renter's insurance to cover liability in the event of an accident/negligence of the tenant; however, renters frequently purchase the required insurance on a monthly basis for a short period of time, and then drop the policy after moving into the property. Consequently, in the event of an accident on the property caused by the tenant, the tenant is not covered by the renter's insurance policy, and the landlord has to pay cash out of pocket for any repairs up to the landlord's deductible.

### SUMMARY OF THE INVENTION

In one implementation a method is disclosed for creating and managing a lease agreement. In the method, information is processed using a preprogrammed lease control computer remote from the lessor, regarding a potential lessee for a lease of a property to carry out tasks of a lease control intermediary. The lease control computer stores predetermined data regarding the potential lessee, and produces one or more physical manifestation of a service product in the form of a guaranty directed to periodic lease payments to be paid by an actual lessee to the lessor. The guaranty may be determined based on payments from the lessee to the lessor. The guaranty is for a predetermined monetary amount defining a guaranty limit. The predetermined monetary amount is to be paid by the lease control intermediary to the lessor upon failure of the potential lessee to pay periodic lease payments, and is to be paid directly or indirectly by the lease control intermediary or a third party, to a party injured on the property.

In another implementation, a computerized system for creating and managing a lease agreement includes a preprogrammed lease control computer that processes information regarding a potential lessee for a lease of a property. The preprogrammed lease control computer may be remote from the lessor and carries out tasks of a lease control intermediary. The lease control computer stores predetermined data regarding the potential lessee. A device is provided that produces one or more physical manifestations of a service product in the form of a guaranty directed to periodic lease payments paid by an actual lessee to the lessor. The cost of the guaranty may be determined based on payments from the lessee to the lessor. The guaranty is for a predetermined monetary amount defining a guaranty limit to be paid by the lease control intermediary to the lessor upon failure of the potential lessee to pay periodic lease payments, and is paid by the lease control intermediary to the lessor upon damages by the lessee to the property, or paid by the lease control intermediary to a party upon injury by the party on the property.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a simplified schematic diagram of system architecture for creating and managing a lease agreement.

FIG. 2 is a simplified schematic diagram of a lease control intermediary computer shown in FIG. 1 to create and manage a lease agreement.

FIG. 3 is a flow chart of a process for creating and managing a lease agreement using the lease control intermediary computer shown in FIGS. 1 and 2.

FIG. 4 is an exemplary physical manifestation of a guaranty generated by the lease control intermediary computer.

### DETAILED DESCRIPTION

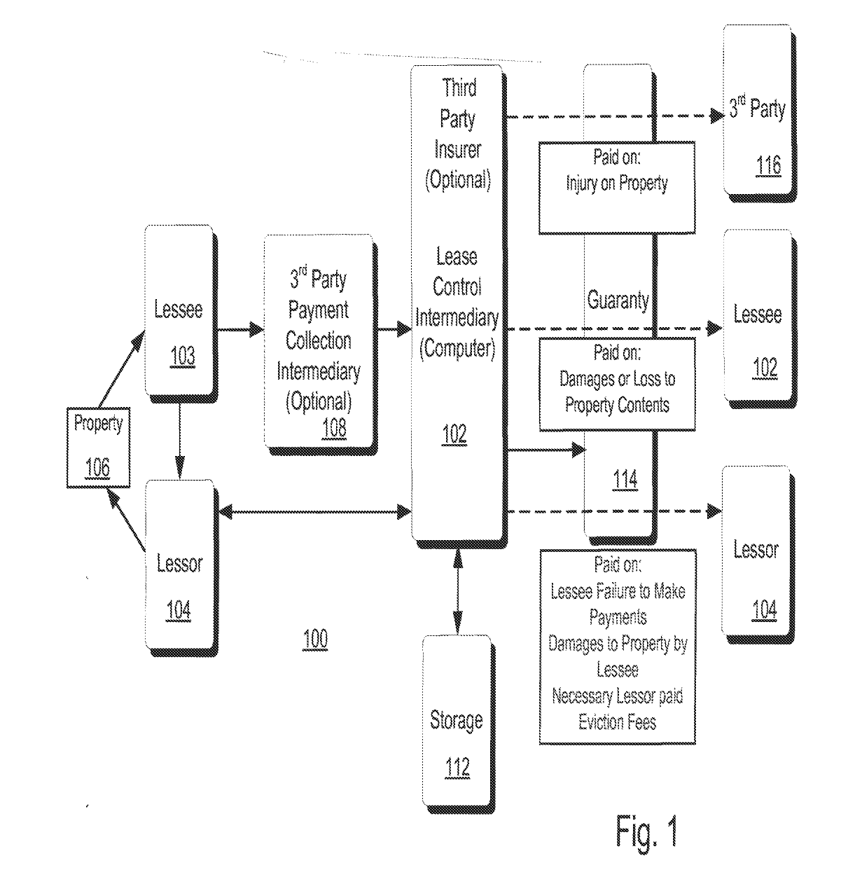

Referring to FIG. 1, exemplary system 100 is shown to create and manage a lease agreement. System 100 includes a preprogrammed lease control computer 102 that receives information in the form of tasks from a lessee 103 (also known as a tenant) and/or a lessor 104 (also known as a landlord) regarding the use of property 106 owned or controlled by the lessor 104. Lease control computer 102 may receive such information via an optional third Party Payment Collection Intermediary 108. Such information may include data regarding the potential lessee and an indication of a credit approval by the lessor 104. Lease control computer 102 may store such received information and access programs from storage 112. Lease control computer 102 includes instructions to generate a guaranty 114 (that may include a physical manifestation, a lease agreement, a lease addendum or a legal document/contract) that directs the lease control intermediary 108 when and how to pay to a third party 116, lessor 104 or lessee 103. The guaranty may also include language providing for (or referencing another document that provides for) a third party insurer to pay a third party 116, the lessor 104 or the lessee 103 in the event of damages or injury on the property. The lease control computer may be a server or a web site for receiving information provided over a network, such as the world wide web or the Internet.

The guaranty 114/physical manifestation may be a service product in the form of a guaranty that defines periodic lease payments to be paid by an actual lessee to the lessor. The manifestation may also state a cost of the guaranty that, in one implementation, is determined based on the amount of the payments made from the lessee to the lessor. The physical manifestation may define a guaranty for a predetermined monetary amount and may define a guaranty limit to be paid by the lease control intermediary 102 (or a third party insurer) to the lessor 104. The monetary amount could be paid upon failure of the lessee 103 to pay periodic lease payments, and could be paid by the lease control intermediary 102 to the lessor 104 upon 1) damages by the lessee 103 to the property or 2) to by the lease control intermediary 102 to a 3.sup.rd party 116 upon injury by the third party on the property. In one implementation, the predetermined monetary amount defining a guaranty limit to be paid by the lease control intermediary to the lessor could include legal eviction fees. In a further implementation the monetary amount could be provided to the lessee by the lease control intermediary or the third party insurer for any liability claim, e.g. identity theft loss, loss of employment, or stolen credit cards.

In another implementation, the guaranty 114 could specify that the predetermined monetary amount to be paid by the lease control intermediary 102 or the third party insurer to the lessee 103 upon damages or loss to contents of the lessee in the property 106.

In a further implementation, the guaranty could require that the payments by the lessee to the lessor be made via a third party collection intermediary 108. The payments made to lease control intermediary 108 could be a function of the monitory amount of the lease payments or could be set based on a maximum lease payment. The guaranty could further specify that a portion or a percentage of the one or more payments by the lessee 103 to the third party collection intermediary 108 be paid to the lessor 104 and another portion or percentage of the payments be made to the lease control intermediary 102. The guaranty could also provide that if the lessee provides periodic payments to the lease control intermediary via a payment collection intermediary 108, the lessee's upfront payment could be reduced. In one implementation, the periodic payments may be bi-weekly with the additional bi-weekly payments (on months with more than two payments) going to the lessee's reserve account. The reserve account may be used to pay for future guaranty renewals (or may cover the initial guaranty).

The lease control computer 102, in another implementation, produces a physical manifestation of the service product in the form of a renewal guaranty directed to periodic lease payments paid by the actual lessee to the lessor. The renewal guaranty can be determined based on the amount of the payments made from the lessee to the lessor. The renewal guaranty can be for another predetermined monetary amount defining the guaranty limit to be paid by the lease control intermediary to the lessor upon failure of the potential lessee to pay periodic lease payments. The monetary amount can specify a guaranty limit to be paid by the lease control intermediary or the third party insurer to the lessor upon damages by the lessee to the property. The monetary amount can also be paid by the lease control intermediary or the third party insurer to the lessee upon damages or loss to the contents of the property. Further the renewal guaranty can provide for an upfront payment by the lessee to be made to the lease control intermediary. In another implementation, the upfront payment for the renewal guarantee could be less than the upfront payment for the initial guarantee.

The guaranty can provide for a portion of the one or more payments made by the lessee paid to the lease control intermediary to be placed in an account to fund the renewal guaranty. The guarantee can also provide for a transfer of the guarantee from the initial property to another property that the lessee may choose to lease.

The lease control computer may include instructions for automatically sending an electronic reminder message to the lessee containing selectable options for the renewal guaranty when the term is over or near the end of the term of the lease.

### Example

### Lease Control Intermediary Computer

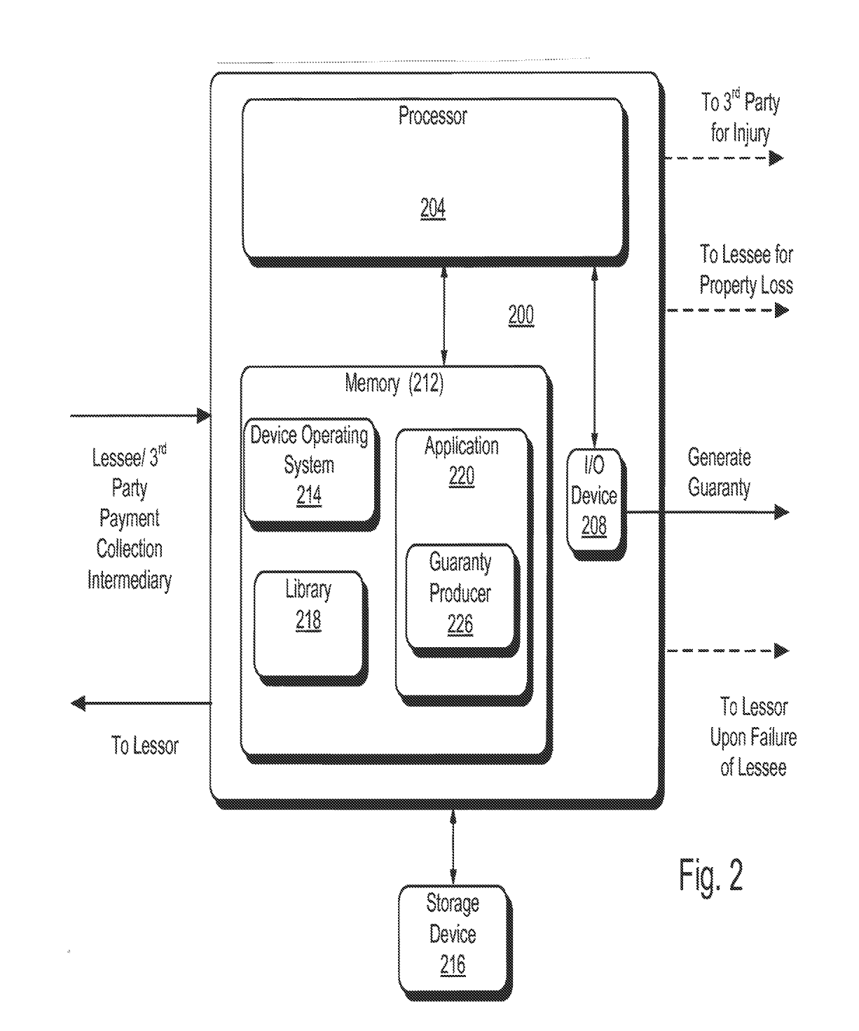

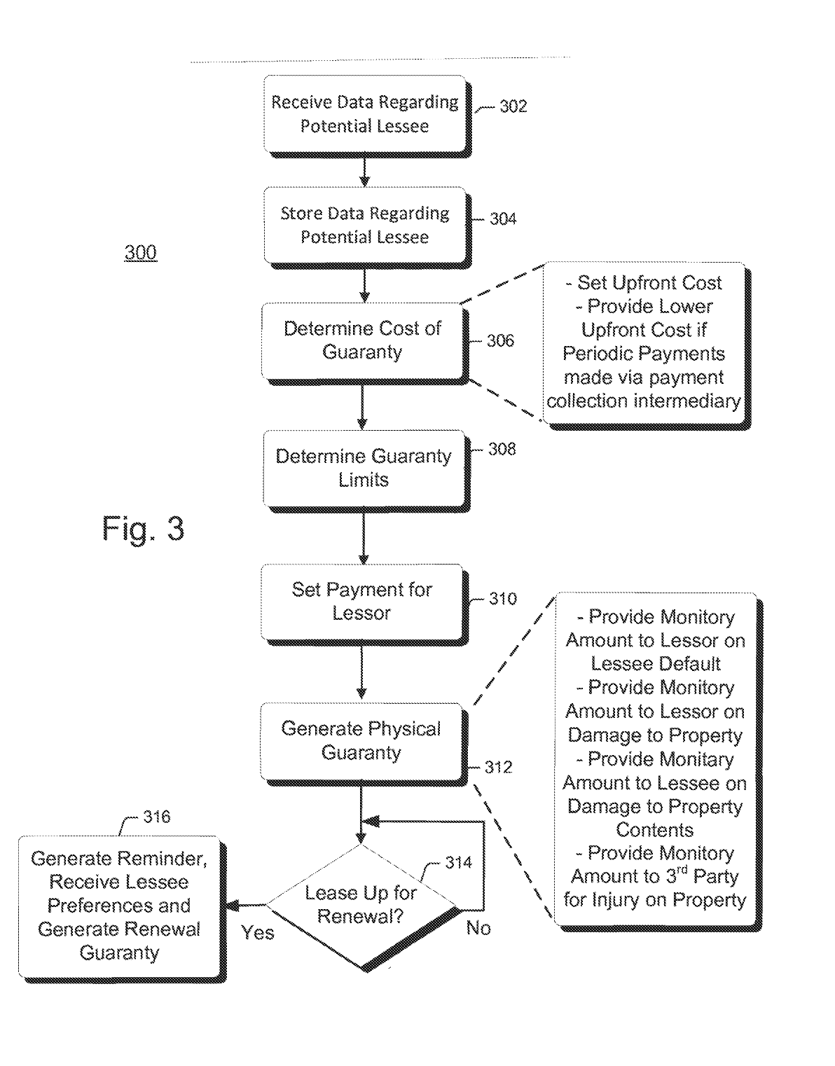

Illustrated in FIG. 2 are selected modules of the Lease Control Intermediary Computing device 200 (Computer 110 of FIG. 1) using process 300 shown in FIG. 3. Computing device 200 may be a freestanding device or may be disposed in a networked computer connected to the Internet or a network. Computing device 200 includes a processing device 204, memory 212, and Input/Output (I/O) device 222. Computing device 200 may include one or more microprocessors, microcontrollers or any such devices for accessing memory 212 or I/O device 208. Computing device 200 has processing capabilities and memory suitable to store and execute computer-executable instructions.

Computing device 200 executes instructions stored in memory 212, and in response thereto, processes signals from I/O device 208 or standard computer hardware (not shown). Hardware may include a display, an input device and an I/O communications device 208. I/O communications device 208 may include a network and communication circuitry for enabling processor 204 to communicate with network 104, a printer or other peripheral device.

The input device receives inputs from a user of the computing device 200 or a mobile computing device (such as a laptop, a smart phone, a cell phone, PDA or a tablet PC) and may include a keyboard, mouse, track pad, microphone, audio input device, video input device, or touch screen display. Display device may include an LED, LCD, CRT or any type of display device to enable the user to preview information being stored or processed by computing device 204.

Memory 212 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 212 of the computing device 200 is an operating system 214, a communications system application 220 and a library of other applications or databases 218. Operating system 214 may be used by application 220 to control hardware and various software components within computing device 200. The operating system 214 may include drivers for device 200 to communicate with I/O communications device 208. A database or library 218 may include preconfigured parameters (or may be set by the user before or after initial operation) such as server operating parameters, server libraries, HTML libraries, API's and configurations. An optional graphic user interface or command line interface may be provided to enable application 220 to communicate with the display.

Application 220 includes a guaranty producing module 226. Producer module 226 includes instructions that processor 204 uses to process information, within the preprogrammed lease control computer 200, regarding a potential lessee for a lease of a property to carry out tasks of a lease control intermediary 200.

The instructions, when executed by the processor, store with the lease control computer 200 predetermined data regarding the potential lessee. The instructions, when executed by computer 200, produce a physical manifestation of a service product in the form of a guaranty directed to periodic lease payments paid by an actual lessee to the lessor and/or payments to be paid by the actual lessee to the third party insurer. In one implementation, the physical manifestation/lease agreement/lease addendum/contract/guaranty agreement is a text document. The text document may be produced using a printer coupled with I/O device 208, may be displayed on a computer screen or may be provided via e-mail. The instructions provide for the cost of the guaranty to be established based on payments from the lessee to the lessor. The guaranty provides for one or more of the following:

1) a predetermined monetary amount defining a guaranty limit,

2) a portion of the predetermined monetary amount to be paid by the lease control intermediary to the lessor upon failure of the lessee to pay periodic lease payments,

3) a portion of the predetermined monetary amount be paid by the lease control intermediary or the third party insurer to the lessor upon damages by the lessee to the property,

4) a portion of the predetermined monetary amount to be paid by the lease control intermediary or the third party insurer to a party upon injuries to the party while on the property, and

5) a portion of the predetermined monetary amount to be paid by the lease control intermediary or the third party insurer to the lessee upon damages or loss to the contents of the property.

6) a portion of the predetermined monetary amount to be paid by the lease control intermediary to the lessor for legal eviction fees upon failure of the lessee to pay periodic lease payments.

Illustrated in FIG. 3, is a process 300 for creating and managing a lease agreement. The exemplary process in FIG. 3 is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 3, although it may be implemented in other system architectures.

Referring to FIG. 3, process 300 is shown for Creating and Managing a Lease Agreement System Architecture. In one implementation, process 300 is executed in a computing device, such as lease control computing device 200 (FIG. 2). Application 220, when executed by the processing devices, uses the processor 204 and modules 208-226 shown in FIG. 2.

In block 302, application 220 in computing device 110 receives and processes information to carry out tasks of a lease control intermediary. The received information includes predetermined data pertaining to a potential lessee for a lease of the property.

In block 304, application 212 stores in storage device 216 the predetermined data regarding the potential lessee. The predetermined data regarding the potential lessee could include an indication of a credit approval by the lessor or the potential lessee's credit rating.

In block 306, application 212 determines a cost of a guaranty based on payments from the lessee to the lessor. The guaranty is for a predetermined monetary amount that defines a guaranty limit. In one implementation, the predetermined monetary amount is to be paid by the lease control intermediary to the lessor upon failure of the potential lessee to pay periodic lease payments. Further, the predetermined monetary amount may be paid by the lease control intermediary or the third party insurer upon injury on the property to a party. Such payments may be paid directly or indirectly from the lease control intermediary and/or or the third party insurer to the injured party. In another implementation, the cost of the guaranty may be a predetermined upfront cost. The cost may be a percentage of the amount of rent being paid. The percentage may be increased if the lessee requires additional liability or other insurance coverage (e.g. for identity theft coverage, personal property coverage). In one implementation the percentage may be changed when the lessee moves to a new dwelling with a different rent payment. The predetermined monetary amount defining a guaranty limit to be paid by the lease control intermediary to the lessor could include legal eviction fees.

In one implementation, the guaranty could provide for the lessee to provide periodic payments to the lease control intermediary (and/or the third party insurer) via a payment collection intermediary to reduce the upfront payment/costs, where the periodic payments may be bi-weekly, with the additional bi-weekly payments (on months with more than two payments) going to pay the balance of the upfront payment/costs.

In block 308, computing device 110 determines the guaranty limits of the guaranty. Such limits may be predetermined and set based on one or more of the following characteristics: the amount paid for the lease, the monthly lease payments, the credit worthiness of the Lessee, the risk historically of similar properties and the value of the property. The guaranty may be for a predetermined monetary amount that defines the guaranty limit to be paid by the lease control intermediary or the third party insurer to the lessee upon damages or loss to the contents of the property.

In block 310, a payment for the lessor to the lease control intermediary and/or the third party insurer is determined. Such determination may be based on a percentage of monthly lease payments or based on a maximum rental amount.

In block 312, application 220 produces, using I/O device 208, a physical manifestation of a service product in the form of a guaranty directed to periodic lease payments paid by an actual lessee to the lessor. In one implementation, the guaranty may be for:

1) a predetermined monetary amount that defines the guaranty limit to be paid by the lease control intermediary or a third a party intermediary insurer to the lessee upon damages or loss to the contents of the property, accidental damage to the property, or injury to a person on the property;

2) a predetermined monetary amount that defines the guaranty limit to be paid by the lease control intermediary to the lessor upon Lessee Default;

3) a predetermined monetary amount that defines the guaranty limit to be paid by the lease control intermediary or the third party insurer to the lessor upon damages to the property; or

4) a predetermined monetary amount that defines the guaranty limit to be paid by the lease control intermediary or 3rd party insurer to an injured 3rd party upon injury of the injured 3rd party on the property.

In another implementation, the guarantee may provide that one or more payments by the lessee be made to the lease control intermediary and/or or the third party insurer and may specify the monitory amount of the payments.

In block 314, a determination is made by application whether the lease is up for renewal. A determination continues to periodically be determined in block 314 until the lease is up for renewal.

If the lease is up for renewal, in block 316, a reminder is generated for transmission via e-mail or SMS for transmission to the lessee. The reminder may include a list for lessee to select preferences to generate a renewal guaranty. Such selection may be done via the computer 110 (e.g. using a web site).

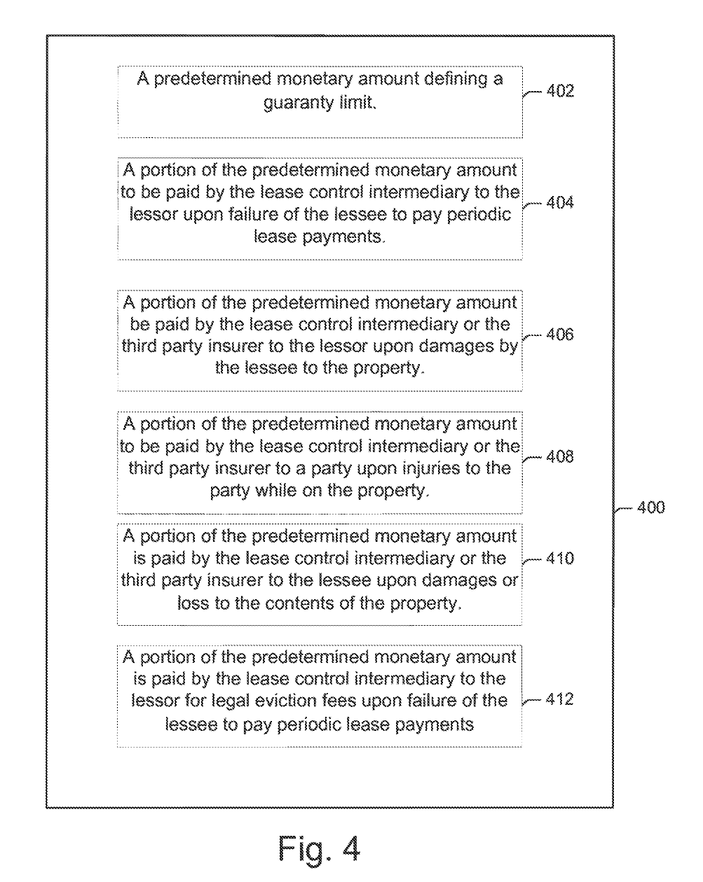

FIG. 4 shows an exemplary physical manifestation of a guaranty 400 generated by the lease control intermediary computer 110 to govern the terms of an agreement between the Lessee and the Lessor. The Guaranty 400 may specify one or more of the following terms: 1) a predetermined monetary amount defining a guaranty limit 402; 2) a portion of the predetermined monetary amount to be paid by the lease control intermediary to the lessor upon failure of the lessee to pay periodic lease payments 404; 3) a portion of the predetermined monetary amount be paid by the lease control intermediary or the third party insurer to the lessor upon damages by the lessee to the property 406; 4) a portion of the predetermined monetary amount to be paid by the lease control intermediary or the third party insurer to a party upon injuries to a party while on the property 408; 5) a portion of the predetermined monetary amount is paid by the lease control intermediary or the third party insurer to the lessee upon damages or loss to the contents of the property 410; and/or 6) a portion of the predetermined monetary amount is paid by the lease control intermediary to the lessor for legal eviction fees upon failure of the lessee to pay periodic lease payments 412.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

### Example

### Lease Policy

The lease deposit policy provides the landlord a guaranty against unpaid damages and unpaid rents (see below), including cancellation fees and other related expenses, with certain limitations, that the lessee or resident agrees to pay to the lessor or landlord. The subrogation amount for each resident who has completed a membership enrollment for and paid a premium shall be limited to defined coverage(s) or the actual loss, whichever is less.

To begin the process of obtaining the guaranty, the resident completes an enrollment agreement and pays the premium. Enrollment is optional for the resident, who may otherwise be required to make a security deposit. Then the agreement must be approved by the company's agent.

Obtaining the guaranty or membership and associated exemptions from posting a deposit and purchasing damage liability insurance are transferable among the landlord's or the company's communities at no additional charge, once a transfer form is filed with the company.

The lease deposit exemption policy covers unpaid damages and unpaid rents only if the payment occurred after the beginning of the policy and continues under subsequent enrollment of the resident. The landlord agrees to apply and use standards set by local and state landlord/tenant laws, particularly as those apply to “damages,” “loss of rents” and “normal wear and tear.”

The policy serves as a guarantee of the resident's performance, up to the specified limits, consistent with the payment obligations in the lease, including payment of rent, payment for repairs, and payment of eviction legal process fees. The term of the policy is the resident's lease period, or the expiration or termination of the Resident's lease for any reason.

When the Resident fails to pay a covered item(s), the landlord files a claim for payment according to the claims procedure, in which the landlord follows the minimum required delinquency procedures, move-out procedures, and collection procedures. Then the company pays the resident's unpaid debt to owner. Following are exemplary procedures:

For accelerated rent, or “skip payment”, one such guaranty is about 1.5 months of rent. Here, a resident who had been current on the rent vacates prior to the end of the lease term and fails to pay the remaining monthly rent payments according to the lease, or fails to pay the early termination or liquidated damages fee (if any). If owner cannot collect from the resident after following the required move-out and collection procedures, the landlord may file a claim with the company, and the company pays the landlord 1.5 months' rent (or the actual balance due, whichever is less).

For past due rent payments, one such guaranty is about three months of rent. Here a resident is delinquent on rent vacates (at any time) with a past due rent balance. If the landlord cannot collect from the resident after following the required delinquency, move-out and collection procedures, the landlord may file a claim and assign the past due rent balance and all rights of collection to the company. The company pays the owner up to three months rent (or actual balance) whichever is less. When the resident leaves prior to the lease end, the resident's action is also characterized as a “skip,” and the landlord can add a skip payment of 1.5 months to the amount sought; however, the maximum available for the combined Skip and Past Due rent is the equivalent of three months of rent. These payments are conditioned upon assignment of collection rights to the company.

For a past due repair payment, one such guaranty is about one month of rent. Similarly, if the landlord cannot collect from the resident and follows procedures, the landlord can file a claim and assign the right of collection to the company, and the company will pay the repair amount up to about one month of rent.

For past due eviction fees payment, the guaranty provides for a flat amount of about $350 to 500. If the landlord incurs an eviction legal process fee(s) in removing a resident, and the landlord cannot collect those fees from the resident after following the usual procedures, the landlord files a claim and assigns the past due eviction fees and right to collect to the company, and the company pays the owner up to the agreed upon amount (or the actual balance due, whichever is less).

Of course, if the landlord and resident agree on a lease break, the company does not pay a claim. Nor is the company responsible if the landlord decides to redecorate or for ordinary wear and tear.

Applicant screening is a requirement for the landlord to later collect on the guaranties. In the same manner that the landlord used for security deposits, the landlord must investigate and verify each applicant's rental application, including credit, criminal background and rent history to assure that the applicant meets the landlord's standard resident qualifications. The landlord accepts or denies the applicant based on the usual standards without considering the additional risk mitigation afforded by the guaranty. Any applicant must execute the landlord's usual lease form. The company's enrollment form and agreement must be signed by the applicant and becomes an addendum to the resident's lease. The landlord cannot accept an otherwise unacceptable resident's application. The landlord cannot change any resident's application to appear to meet the landlord's criteria, if the applicant does not qualify.

Preferably the landlord agrees to “scan deposit” the company payments directly into the company's bank account with the provided scanner and software. The agreement with the company comes into effect after the company receives the payment. The term of the policy begins as of the effective date of the signatures. However, enrollment occurs upon the company's receipt of both the full premium payment and the enrollment form. The enrollment period continues for the life of the resident's tenancy. This period includes relocations of the resident to another apartment/rental unit owned or operated by the landlord.

The landlord provides a signed copy of the rental/lease agreement with the written notice of claim. The rental/lease agreement must have obligated the Resident for the payment of rents, cancellation penalties and other associated expenses for a claim to be successfully made under this policy. The Owner must compute claims and damages strictly in accordance with the procedures established in the lease and/or as may be mandated by applicable law. Any cash security deposits held by the Owner on behalf of the Resident, in addition to this policy, must be applied to the payment of Damages and/or Loss of Rents in full before a claim can be successfully brought hereunder.

If the claim alleges Unpaid Damages, upon request, Owner must provide Company with photographs of sufficient clarity and number to document the Damages.

In order for a Claim to be valid, Owner, or Owner's Agent, must first follow the required Delinquency, Move Out and Collections procedures, as specified below:

Delinquency Procedure. Deliver “3-Day Notice to Cure” to Resident within 24 hours of delinquency (or the earliest allowed by state and local laws). Begin Eviction Proceedings and deliver “Notice to Evict” to Resident if delinquency is not cured within three days (or the earliest allowed by state and local laws).

Move-Out Procedure: Follow standard move-out procedure that is followed for all Residents. Within 3 days of Resident vacating apartment, conduct walk-through inspection, and prepare and deliver to Resident a “Disposition Letter” with a final accounting, description and photos of damage (if there is damage), a copy of the invoice (or estimate) for repairs, and a “7-Day Notice of Balance Due Immediately”.

Collections Procedure: If Resident fails to pay the balance due within seven days of delivery of the “Disposition Letter” and the “7-Day Notice of Balance Due”, deliver a “7-Day Demand for Payment” that includes special language reminding the resident of responsibilities and that without payment the balance may be turned over to the company for collection.

Further followup is important, including speaking to the Resident, either in person or by telephone (or by leaving a voicemail message, if Resident's phone is still active) at least once during the 7-day period and attempt to collect the Balance Due. Keep a record of the date, time and what was discussed in the conversation (or voicemail message), as LeasePal will need this information to approve the claim and to use in its collection efforts.

Procedure for filing a Claim. Claims can be filed online or manually—either way—with complete information and supporting documents. Required supporting Documents always include copies of all notices, collection letters, notes from collection phone call, move-in and move-out reports, damage photos and repair invoices or estimates (if damage is claimed), pleadings and judgments (if any), a copy of the Lease, and other papers served or filed in connection with the Lease, Delinquency, Move Out and/or Collections associated with the Resident. The company may request additional documentation and Owner agrees to cooperate with the company and furnish all pertinent information in Owner's possession, or to which Owner has access.

The company has the right to inspect the Apartment and contact the Resident following Owner's filing of a Claim. There may be a time limit on filing claims for the claim to be honored.

Subrogation. When the company pays Owner on a Claim, the company will automatically have all rights of subrogation in regard to the Resident's failure to pay and the assignment of the unpaid debt to the company. Owner will not act, or omit to act, in any way to impair the company's right of subrogation. In the event that Owner obtains a money judgment against the Resident, such judgment will be deemed immediately and automatically to be assigned to the company, and Owner will immediately notify LeasePal of such judgment and pay the company any amount collected against such judgment. If the Company makes Payment to Owner pursuant to a Claim hereunder, and Resident subsequently pays Owner all, or part, of the Claim, Owner must pay the property of Company and agrees to immediately pay to the Company the entire amount collected.

If the Company determines that a Claim contains, or contained, a Material Misstatement, Material Misrepresentation, Material Omission by Owner or Owner's Agent, or was submitted Fraudulently, then in Addition to any and all rights and remedies permitted by law or otherwise set forth herein, Company can reject the Claim and seek reimbursement from Owner for any and all amounts paid in respect to such Claim.

As an incentive and in return for administrative services, the owner is entitled to receive remuneration (a “Subsidy”) to enroll Residents in LeasePal and provide Residents with an exemption from the security deposit and an exemption from the damage liability insurance.

On one embodiment, the Subsidy equals 10% of the LeasePal enrollment fee. Payment(s) of the Subsidy will be by ACH or by Direct Deposit on a weekly basis for all Resident enrollment checks that cleared funds in the previous week.

CANCELLATION/TERMINATION/NON-RENEWAL. Regarding cancellation, the Owner may cancel by mailing a cancellation request to the Company or its Agent.

The Company may cancel this policy by mailing first class or by hand delivery to the Owner written notice of cancellation at least 30 days before the effective date of cancellation.

The Company will mail or deliver any notice of cancellation or any other notice to be delivered under the Policy to the Owner's mailing address shown in the policy. Notice of cancellation will state the effective date of cancellation and no additional Resident enrollments are accepted. If notice is mailed, a prepaid proof of mailing is sufficient proof of notice to the Owner. Notice deposited in the mail in the manner described above shall be effective when so deposited.

If the Company decides not to renew this policy, the Company sends notice no later than 30 days before non-renewal.

At no time will cancellation of this policy for any reason require the Company to refund premium. Premiums set out in this policy are considered fully earned premium.

This Policy contains all of the agreements between the Owner and the Company.

Notice by the Owner to any agent or service provider, or knowledge possessed by any agent or service provider, or by any other person shall not effect, waive or change any part of the coverage provided the Owner under the Policy, or limit the Company from asserting any right under the terms of the Policy.

Upon cancellation or termination, Company shall remain liable with respect to all Residents and owners, covered by this policy as of the effective date of cancellation or termination until the resident “tenancy” ends. This policy shall also terminate concurrently with the termination by any regulatory authority of either party's authority to act in accordance with the terms of this policy in that state.

Fraudulent Acts and Claims. If any Owner or agent, employee of Owner shall make any Claim under this Policy knowing such Claim to be false or fraudulent, as regards amount or otherwise, this Policy shall become null and void and all coverage hereunder shall be forfeited.

The Owner agrees and acknowledges that the act of retaining Premiums from Residents under this policy while not reporting the enrollment of such Residents under this policy may constitute an act of fraud or a violation of state insurance laws on the part of the Owner. The Owner acknowledges that the Company is required by law to report all such suspected violations to the proper authorities and to fully cooperate in the investigation and prosecution thereof.

In the absence of local or state landlord/tenant law providing a definition, the following definitions will apply:

Unpaid Damages. Defined as the Resident's failure to pay Owner for physical damage to the leased premises, exclusive of damages resulting from normal wear and tear. “Normal wear and tear” is defined as (1) wear and/or soiling of carpeting, walls, ceiling, windows, blinds/drapes, bathroom fixtures, appliances, etc; which is not excessive, and/or (2) the depreciation in value of the leased premises that occurs as a result of ordinary and reasonable use of the leased premises and not as a result of negligence, carelessness, accident or abuse. Specifically excluded from this definition of Unpaid Damages and specifically excluded from the coverage hereunder in the event of non-payment are the normal post-vacancy cleaning of the leased premises' carpet, appliances, bathrooms and walls, the normal post-vacancy repair of the leased premises' nail holes and the normal post-vacancy painting of the leased premises' walls, unless such normal post-vacancy cleaning and repairs are specifically made a responsibility of the Resident under the terms of the lease agreement.

Unpaid Rents. Defined as the Resident's post-vacancy failure to pay Owner for rents, cancellation fees and related expenses arising out of a rental/lease agreement between Resident and Owner.

Unpaid Eviction Legal Fees. Defined as the Resident's post-vacancy failure to pay Owner for legal fees arising out of a rental/lease agreement between Resident and Owner, whereby Owner takes legal action to evict Resident.

Resident. Defined as one or more individuals who rent a single residential housing unit owned or managed by Owner and who agrees to enroll in LeasePal.

Life of Tenancy. Defined as the period beginning with the initial leasing of a residential unit by the Resident and continuing until the lease has ended or the Resident has vacated; including any and all transfers to any other residential unit owned or managed by the Owner. In the event of transfer, occupancy must be continuous and no claim may be presented to previous residential unit.

1. A computerized method for creating a deposit exemption policy between a lessor and a third party insurer, the policy obviating the need for a security deposit, said method comprising:
a) obtaining and processing information from a potential lessee, using a preprogrammed lease guaranty computer remote from the lessor, to carry out tasks of a lease control intermediary;
b) storing with said lease control computer predetermined data regarding the potential lessee;
c) requiring the lessor to follow a usual due diligence process for qualifying a lessee;
d) optionally determining the specific amount based on payments from said lessee to said lessor;
i) to be paid by the lease control intermediary to the lessor upon failure of said actual lessee to pay periodic lease payments and
ii) to be paid directly or indirectly by the lease control intermediary or a 3rd party insurer, upon injury on the property, to the injured party; and
e) producing a physical manifestation of a certificate indicating a deposit exemption policy for a specific amount.
